(19) United States
(12) Patent Application Publication
(10) Pub. No.: US 2007/0095759 A1
(43) Pub. Date: May 3, 2007

(54) METHOD AND APPARATUS FOR TREATING WATER TO REDUCE BOILER SCALE FORMATION

(75) Inventor: Michael K. Bridle, Houston, TX (US)

Correspondence Address: LOCKE LIDDELL & SAPP LLP, 600 TRAVIS, 3400 CHASE TOWER, HOUSTON, TX, 77002-3095, US

(73) Assignee: WORLEYPARSONS GROUP, INC., Houston, TX (US)

(21) Appl. No.: 11/553,604

(22) Filed: Oct. 27, 2006

Related U.S. Application Data
(60) Provisional application No. 60/731,176, filed on Oct. 28, 2005.

(51) Int. Cl. C02F 1/42

(52) U.S. Cl. 210/687; 210/284

(57) ABSTRACT

A process for treating water to reduce silica based compound scaling in steam generation equipment is provided, including the step of subjecting water to a cation removal process to reduce the di- and trivalent cation concentration within the water to, most preferably, less than about 20 ppb prior to introducing the water into the steam generation equipment. This process eliminates the need for a lime softening stage and savings in capital and operating costs are realized.

### CROSS REFERENCE TO RELATED APPLICATIONS

This application claims priority to and benefit of U.S. provisional application no. 60/731,176, filed on Oct. 28, 2005.

### STATEMENT REGARDING FEDERALLY SPONSORED RESEARCH OR DEVELOPMENT

Not applicable.

### REFERENCE TO APPENDIX

Not applicable.

### BACKGROUND OF THE INVENTION

1. Field of the Invention

The present invention relates generally to treatment processes for water to reduce the propensity for high temperature scaling and, more particularly, to a process for cation removal from produced water during Enhanced Oil Recovery (EOR) processes to reduce or prevent scaling within steam generation equipment.

2. Description of the Related Art

As primary hydrocarbon recovery processes become inefficient, the Oil and Gas industry has turned to secondary and tertiary recovery processes, such as Enhanced Oil Recovery (EOR) processes, including, but not limited to, Steam Assisted Gravity Drainage (SAGD) processes. SAGD processes are especially beneficial at recovering heavy oil reserves. The most common type of boiler found in EOR processes, such as SAGD, may be characterized as Once Through Steam Generators, or OTSGs.

The quality of feedwater suitable for conventional OTSGs was proposed some twenty-five years ago and has changed little since that time. Typically, OTSGs used in SAGD processes operate at steam pressures in the range of about 8,400 to 11,200 kPa, although these boilers may generate steam at pressures up to about 15,400 kPa. Currently, the accepted water quality for steam generation equipment, such as an OTSG, is understood to be:

Total Hardness less than or equal to 0.5 mg/L as CaCO₃ (calcium carbonate)

Silica less than or equal to 50 mg/L

Total Dissolved Solids less than or equal to 12,000 mg/L

Oil & Grease less than or equal to 10 mg/L

EOR processes, such as SAGD, typically produce water along with the desired production of hydrocarbons, such as heavy oil. In contrast to the desired quality for boiler feedwater, water produced by an SAGD process is typically characterized by low values or concentrations of both total hardness (TH) and total dissolved solids (TDS), and high silica concentrations. Treatment of these produced waters to provide suitable feedwater for process boilers, such as OTSGs, has traditionally included either hot or warm lime softeners (HLS/WLS) and ion exchange units. The primary function of the lime softening process is to remove silica to reduce or prevent scaling within the steam generator.

For example, PCT application WO 2005/054746 purports to disclose an evaporation method for the production of high-pressure steam from produced water for use in heavy oil production industry including SAGD.

PCT application WO 2004/050567 purports to disclose a water treatment method for heavy oil production using an evaporation-based method of treating water produced from heavy oil production.

U.S. Pat. No. 6,733,636 purports to disclose an evaporator-based water treatment method for heavy oil production to provide feedwater for the production of high quality steam including electrodeionization or ion exchange treatment.

U.S. Pat. No. 4,969,520 purports to disclose a steam injection process for recovering heavy oil in which feedwater is treated by ion-exchange resins to remove certain cations from the water.

U.S. Pat. No. 3,714,985 purports to disclose a steam oil recovery process.

U.S. Pat. No. 3,410,345 purports to disclose a steam generation process in which steam feedwater is treated with ion exchange resins.

U.S. Pat. No. 3,353,593 purports to disclose a steam injection process with clay stabilization.

The inventions disclosed and taught herein are directed to methods and apparatuses that effectively and efficiently treat water for use in steam generation equipment and processes.

### BRIEF SUMMARY OF THE INVENTION

One aspect of the present invention comprises a process for treating water to reduce high-temperature silica-based scaling and involves providing water having a silica concentration and a cation concentration; and reducing the amount of cations in the water to thereby produce treated water having a decreased propensity to form silica-based high-temperature scale.

Another aspect of the present invention comprises a process for treating produced water from a steam-based enhanced oil recovery process to reduce silica scaling in steam generation equipment and involves subjecting the produced water to a primary and/or polishing process to reduce total hardness of the water to less than about 0.5 mg/L; subjecting the produced water to a chelating ion exchange process to create a treated water having a divalent cation concentration of about less than 40 parts per billion and a trivalent cation concentration of about less than 40 parts per billion; and introducing the treated water a steam generator to create steam for use in a hydrocarbon reservoir.

Yet another aspect of the present invention is a system for treating water to reduce silica-based scaling in steam generation equipment comprising a first ion exchange apparatus for reducing the total hardness of the water to less than about 0.5 mg/L as CaCO3; and a second ion exchange apparatus operatively connected to the first apparatus and adapted to reduce the divalent and trivalent cation concentrations of the water to less than about 40 parts per billion and 40 parts per billion, respectively.

Still another aspect of the present invention is a system for generating steam comprising an ion exchange apparatus adapted to treat the water by reducing the cation concentrations to less than about 40 parts per billion; and a steam generator operatively coupled to the ion exchange apparatus for producing steam from the treated water.

Other aspects and features of the present invention will become apparent to those ordinarily skilled in the art upon review of the following description of specific embodiments of the invention in conjunction with the accompanying figures.

### BRIEF DESCRIPTION OF THE SEVERAL VIEWS OF THE DRAWINGS

Particular embodiments incorporating aspects of the present invention will now be described, by way of example only, with reference to the attached Figures, in which:

FIG. 1 illustrates a conventional SAGD water treatment process for silica removal and total hardness reduction.

FIG. 2 illustrates a water treatment process in accordance with certain aspects of the present invention.

FIG. 3 is a table showing computer simulation results from a particular embodiment of the invention.

### DETAILED DESCRIPTION

The Figures described above and the written description of specific structures and processes below are not presented to limit the scope of what Applicants have invented or the scope of protection for those inventions. Rather, the Figures and written description are provided to teach any person skilled in the art to make and use the inventions for which Applicants seek patent protection. Those skilled in the art will appreciate that not all features of a commercial implementation of the inventions are described or shown for the sake of clarity and understanding. Persons of skill in this art will also appreciate that the development of an actual commercial embodiment incorporating aspects of the present inventions will require numerous implementation-specific decisions to achieve the developer's ultimate goal for the commercial embodiment. Such implementation-specific decisions may include, and likely are not limited to, compliance with system-related, business-related, government-related and other constraints, which may vary by specific implementation, location and from time to time. While a developer's efforts might be complex and time-consuming in an absolute sense, such efforts would be, nevertheless, a routine undertaking for those of skill this art having benefit of this disclosure. Also, the use of a singular term is not intended as limiting of the number of items. Also, the use of relational terms, such as, but not limited to, “top,” “bottom,” “left,” “right,” “upper,” “lower,” “down,” “up,” “side,” and the like are used in the written description for clarity in specific reference to the Figures and are not intended to limit the scope of the invention or the appended claims.

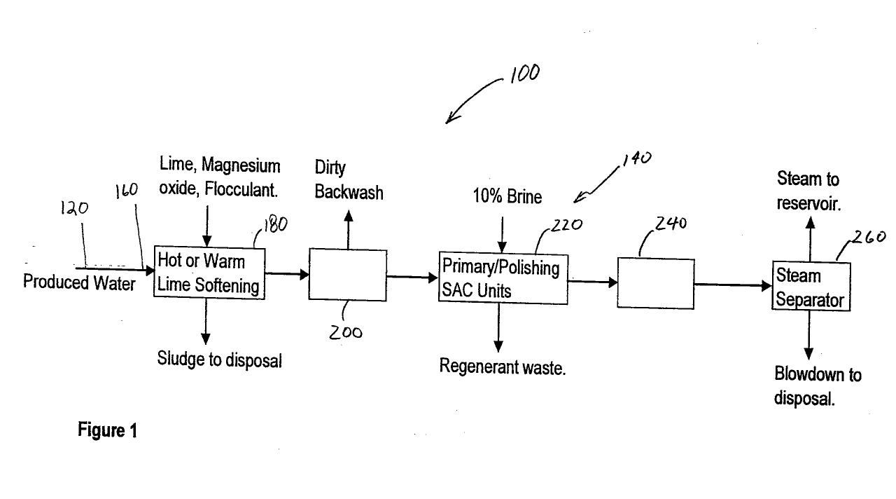

Referring to FIG. 1, in a typical SAGD process 100, produced water 120 is treated in a water treatment plant 140 to obtain a desired water quality before being converted to steam for re-introduction downhole as shown in FIG. 1. A conventional produced water recycling system may also include an appropriate de-oiling system 160 located upstream of the water treatment plant 140 to reduce the oil concentration to less than about 10 mg/L. A skim tank followed by gas flotation and media filtration is considered standard de-oiling equipment and processes.

In conventional systems, hot lime softening (HLS) or warm lime softening (WLS) processes 180 are used reduce the silica content in the produced water and, in certain cases, to reduce the total hardness (TH). After-filters 200 remove sludge carryover from the lime softening process 180. Ion exchange unit 220, such as a primary and/or polishing system or a strongly acidic cation unit (SAC) operating in the sodium form, reduce the TH to less than about 0.5 mg/L as CaCO₃. The OTSG 240 generates steam at about 80% quality and a steam separator 260 removes the 20% water phase from the steam, which is then sent to the reservoir as 100% quality steam.

In the conventional lime softening process 180, lime, magnesium oxide and a flocculent are added to either an HLS or WLS operating at a pH of about 9.5 to 9.8. The lime causes a reduction in the temporary hardness, i.e. the calcium and magnesium combined with the bicarbonate alkalinity, and the magnesium oxide facilitates the removal of the silica. The flocculent aids floc formation so that a sludge that settles more readily is formed. The following equation illustrates the reaction between lime and calcium bicarbonate: Ca(OH)₂+Ca(HCO₃)₂=2CaCO₃↓+2H₂O.

The calcium carbonate is insoluble and precipitates out of solution, simultaneously removing the calcium and bicarbonate from solution. The only other product is water. In a similar reaction, magnesium bicarbonate reacts with lime to produce calcium carbonate and water, but in addition, magnesium hydroxide, which is also insoluble, precipitates out of solution: 2Ca(OH)₂+Mg(HCO₃)₂=2CaCO₃↓Mg(OH)₂↓+2H₂O.

In the conventional system, magnesium hydroxide plays an important role in the removal of silica from solution. The silica removal mechanism is understood to be a combination of absorption and complex ion formation. Usually, insufficient magnesium is present in the produced water to effect complete removal of the silica and additional magnesium in the form of magnesium oxide must be added. The magnesium oxide is converted to magnesium hydroxide in the presence of water by a process known as slaking in which water molecules combine with magnesium oxides: MgO+H₂O=Mg (OH)₂↓.

The calcium carbonate/magnesium hydroxide sludge formed within the lime softening unit 180 is removed, usually via blowdown, and sent to either a sludge pond or centrifuge. In either case, a sludge handling problem is created.

In produced waters from SAGD processes where the TH is frequently less than about 20 mg/L, the use of a lime softening process may actually increases the TH concentration in the effluent. An alternate conventional process that does not increase the TH concentration in the effluent but facilitates silica removal is “caustic softening” in which sodium hydroxide is added to soften the water. Magnesium oxide is also required for silica removal. The caustic raises the pH to the level that is optimum for silica removal. The following equation illustrates a reaction between caustic and calcium bicarbonate: 2NaOH+Ca(HCO₃)₂=CaCO₃↓+Na₂CO₃+2H₂0.

Although this alternate, conventional process is believed to be technically feasible, on occasions where the process was reported, the warm caustic softening process took place in a clarifier of similar design to a WLS and realized limited success due to sludge carryover.

As stated previously, SAGD produced waters are low in hardness and the amount of calcium carbonate precipitated is typically low. The magnesium hydroxide formed by the magnesium oxide slaking is a “light sludge” and would likely predominate in the clarifier because over 200 mg/L of magnesium oxide is normally required for silica removal. Thus, it appears the industry has concluded that the use of either lime softening or caustic softening to treat SAGD produced waters is not ideal.

Furthermore, as is known, the solubilities of calcium and magnesium compounds decrease as the temperature increases, and calcium and magnesium concentrations in any boiler feed-water should be reduced to the lowest concentration practical. However, other cations and in particular strontium, barium, ferric iron, and aluminum in combination either with each other or in the presence of silica readily form insoluble complexes that precipitate out of solution and form scale at the high temperature conditions at which the OTSG must operate.

In contrast, and generally, the present invention provides a method and system for reducing silica-based compound scale formation in EOR processes, such as an SAGD steam generation process. In accordance with the present invention, it has been determined that it is not the existence per se of silica within produced water that causes boiler scaling, but rather the presence of di- and/or tri-valent cations and silica that cause the formation of scale within a boiler. That is, the water content of the vapor phase, the concentrations of the cations within the water phase and the associated pH comprise the parameters that affect whether or not silica will precipitate out of solution and form scale on the steam generation surfaces, such as boiler tubes.

More particularly, it is known that silica is soluble at high pH and temperature conditions that exist in an operating OTSG. The operating quality of the steam may be fixed at 80%, which leaves the adjustment of the di- and tri-valent cation concentrations to reduce the scaling tendencies. As a result, the present invention relates to processes by which the divalent and trivalent cations are reduced to parts-per-billion (ppb) concentration levels such that the silica has little or no multivalent cations to react with, with the result that the scaling reactions are substantially reduced or eliminated.

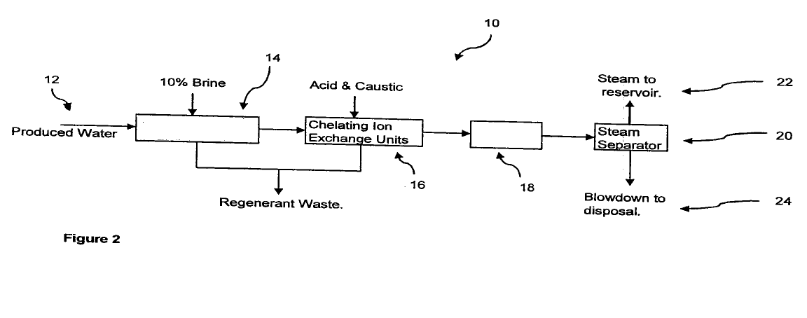

Referring now to FIG. 2, a water treatment process in accordance with the invention is described for re-cycling produced waters, such as form a SAGD, for steam generation without silica removal, such as by lime softening. FIG. 2 illustrates a process 10 for removal of di- and tri-valent cations in accordance with aspects of the present invention. De-oiled, produced water 12 is introduced to an ion exchange system 14, such as a primary and polishing membrane, or an SAC unit, which may be of conventional design, and a chelating ion exchange unit 16 to collectively reduce the di- and tri-valent cation concentrations to less than about 40 ppb, each; preferably to less than about 30 ppb, each; and most preferably to about 20 ppb or less, each. Thereafter, the treated water may be introduced to a steam generator 18, such as an OTSG, to produce appropriate quality steam, which is separated in a steam separator 20 for re-introduction into the reservoir 22 and water phase disposal 24.

It will be appreciated that even at the preferred cation cleanliness of less than about 20 ppb, steam generation equipment using treated water likely will have to be cleaned at scheduled intervals. The time between cleanings is affected by the quality of the boiler feed water and, hence, steam generation equipment fed with water having cation concentrations less than about 20 ppb will require less frequent cleaning than equipment fed with treated water having cation concentrations of less than about 30 ppb.

Returning to FIG. 2, SAC unit 14, preferably operating in the sodium form, reduces the produced water TH to about less than 0.5 mg/L as CaCO₃. Chelating ion exchange unit 16 may use an exchange resin to further reduce the concentrations of all the divalent cations to, most preferably, about 20 ppb or less and trivalent cations to about 20 ppb or less (including calcium and magnesium). The steam generator 18 generates steam at about 80% quality and the steam separator 20 removes the 20% water phase from the steam. The separated steam is then sent to the reservoir 22 as 100% quality steam.

For water, such as produced water, with TDS concentrations of less than about 6000 mg/L (to date, all the SAGD produced waters are believed to have TDS concentrations of less than about 6000 ppm), strongly acidic cation (SAC) resins operating in the sodium form can be used to reduce the TH concentration to less than about 0.5 mg/L as CaCO₃. Primary and polishing units 14, which may be regenerated with 10% sodium chloride solutions, may be used to reach this leakage concentration. The 0.5 mg/L TH remaining, along with the other di- and trivalent cations in the water may be reduced further, preferably to the lowest ppb concentration possible, in order to reduce or prevent reaction with the silica.

Chelating ion exchange resins have functional groups that can form coordinate bonds to a single metal atom. This mechanism is similar to the chelation of calcium and magnesium ions with the strong chelating agent ethylene diamine tetraacetic acid (EDTA). Resins that have chelating capabilities for the removal of TH and metals include, but are not limited to, those containing aminophosphonic acid and iminodiacetic acid. The chelating resins with aminophosphonic acid functional groups selectively remove calcium and magnesium from highly saline solutions and the ones with iminodiacetate functional groups remove the transition elements. Both resin types will remove trivalent aluminum. The two resin types can be mixed in the same vessel since they are both regenerated with acid followed by caustic. This preferred mixture of chelating resins may reduce the concentrations of all the divalent and trivalent cations to the most preferred about 20 ppb or less level, each. It will be understood that other implementations of the present invention may prefer cation reduction of about 30 ppb or less or even 40 ppb or less. Cation reductions of about 10 ppb or less are achievable with the present invention as well.

Chelating resins cost approximately $23 US per liter. The resins may be regenerated with acid and caustic at a dose rate of about 120 grams of each regenerant per liter of resin to produce a resin capacity of about 0.92 meq./ml. In the polisher unit 14, the preferred service flow rate is about 30 bed volumes per hour maximum.

The replacement of the lime softening process and associated chemical storage and handling facilities with chelating ion exchange units downstream of the SAC units14 simplifies the plant layout and reduces the plot area required. Table I, below, provides a listing of the major equipment for a lime softening process versus a chelating resin treatment option according to an embodiment of the present invention for a produced water treatment plant associated with a production plant of about 4000 m³/d of oil and a steam-to-oil ratio of about 3:1. The water boiler feedwater requirement would be abut 500 m3/hr.

TABLE I

| | Chelating Resin Treatment |
|---|---|
| Lime Softening Option | Option |
| One 12 m dia HLS or one 15 m | None |
| dia WLS | |
| Four 3.6 m dia Afterfilters | None |
| Lime Softening Option | Chelating Resin Treatment Option |
| One Filtered Water Storage Tank | None (BFW used for unit |
| | backwashing) |
| One Lime Storage Silo | None |
| Lime slurry feeding equipment | None |
| One Magnesium Oxide Storage Silo | None |
| Magnesium oxide slurry | None |
| feeding equipment | |
| One Sludge Storage Lagoon | None |
| Three 3.6 m dia Primary SAC units | Three 3.6 m dia Primary SAC |
| | units |
| Three 3.0 m dia Polishing SAC units | Three 3.O m dia Polishing SAC |
| | units |
| One Brine Saturator | One Brine Saturator |
| Brine regeneration equipment | Brine regeneration equipment |
| None | Three 3.O m dia Chelating Ion |
| | Exchangers |
| None | One Acid Storage Tank |
| None | Acid regeneration equipment |
| None | One Caustic Storage Tank |
| None | Caustic regeneration equipment |

An estimated capital cost saving of about US$2,000,000 CAD based on equipment supply costs only will occur when a chelating ion exchange option is selected over that of lime softening.

For example, the SAC operating costs will be similar for both treatment options and, therefore, a comparison of chemical costs for the lime softener versus the chelating ion exchange units provides the differential operating cost. The cost to treat one cubic meter of produced water was used to determine the differential operating cost. Delivered chemical costs to the Fort McMurray area in Alberta were used for the comparison.

The chemical costs, all on a 100% basis, were as follows:

Lime=18 cents/kg

Magnesium Oxide=50 cents/kg

Hydrochloric Acid=85 cents/kg

Sodium Hydroxide=60 cents/kg

In the lime softening process, using a dose rate of 200 mg/L. for lime and 110 mg/L for magnesium oxide, the chemical cost to treat one cubic meter of water with a silica concentration of 155 mg/L would be 9 cents CAD. Increasing the silica concentration to a more realistic value of 350 mg/L, the cost increases to 19 cents/m³.

For the chelating ion exchange resin option, a resin capacity of 0.92 meq/mL of resin is obtained with regeneration amounts of 120 grams per liter of resin of both acid and caustic. Based on a leakage of 3 mg/L of divalent/trivalent cations from the SAC units, each chelating ion exchange unit will have a service run of 47 days equating to only 22 regenerations per year. The cost of treating the produced water with chelating ion exchange resin will be 2.5 cents/m³. A savings of 6.5 cents/m³ for produced water with 155 mg/L. silica concentration and 16.5 cents/m³ for a silica concentration of 350 mg/L.

The control of the conventional lime softening processes can be difficult due to the large number of parameters that can be varied which include the chemical injection rates and their concentrations, the rates of return and chemical composition of recycled streams, sludge recycle and blow down rates and operating temperature changes. Process upsets can occur quickly, but may take days to rectify. In contrast, a treatment process in accordance with the present invention that uses only ion exchange has fewer variables. Provided there are no problems with the automatic regenerations, the treated water quality from the process is extremely consistent.

The reduction in the concentrations of the divalent and trivalent cations in SAGD produced waters to about the 20 ppb level or less by the use of chelating ion exchange resins enables the steam generating equipment to operate with produced water with high silica concentrations. Operating at high silica concentrations removes the need for conventional lime softening processes that are currently used to facilitate silica removal. Replacement of the lime softening process with the chelating ion exchange process for an SAGD facility could result in substantial capital cost and operating savings.

A computer program, capable of predicting the types and amounts of scale that is likely to form at the OTSG temperature and pressure operating conditions was used to simulate the effects of using different quality feedwaters. Produced water with the chemical composition as shown below in Table TII was used in the simulations to demonstrate how the scale formation tendency is reduced as the boiler feedwater quality is improved.

TABLE II

| Species | Value (mg/L) |
|---|---|
| Ca | 8 |
| Mg | 0.8 |
| Na | 1420 |
| K | 30 |
| Fe³⁺ | 1 |
| Ba | 0.1 |
| Sr | 0.3 |
| Al | 0.2 |
| Li | 0.9 |
| Mn | 0.2 |
| Co | 0.2 |
| Ni | 0.5 |
| HCO₃ | 237 |
| CO₃ | 0.2 |
| SO₄ | 0.8 |
| Cl | 2200 |
| OH | 0.2 |
| SiO₂ | 155 |
| B | 25 |
| TDS | 4010 |

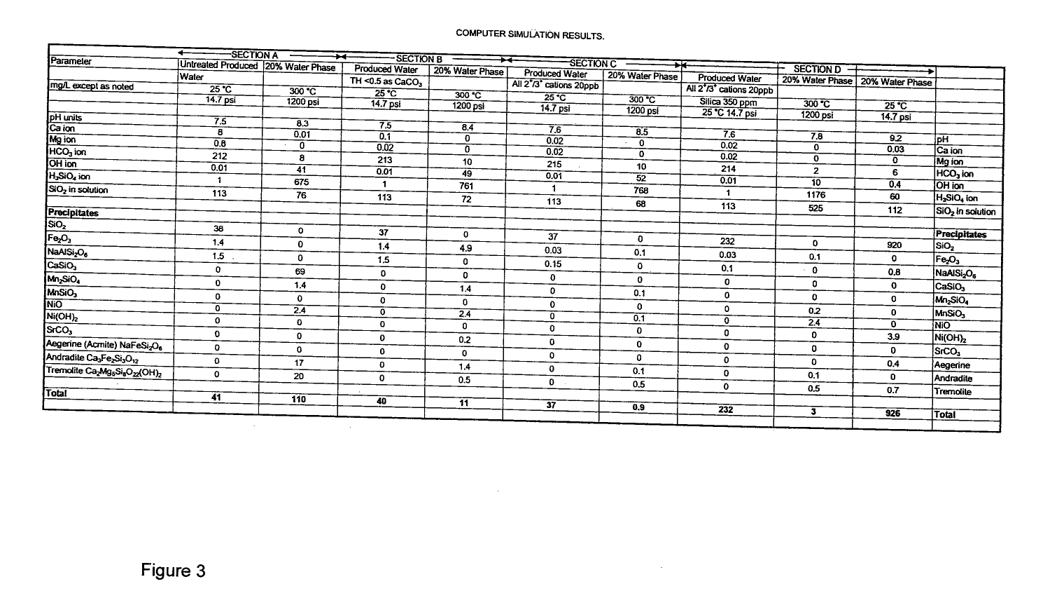

The computer analysis assumed a produced water sample from the early production phase of an SAGD operation having a silica concentration of about 155 mg/L. The silica concentration typically increases with time and a more realistic value for a mature operating field is 350 mg/L. A series of four simulations were run and in each case an OTSG operating at 8400 kPA with a feedwater flowrate of 82 m³/hr was used. FIG. 3 shows the simulation results.

Simulation #1. The first simulation used a boiler feedwater concentration with the ions shown above, i.e. with no total hardness or silica removal. The results are shown in section A of FIG. 3. The produced water at 25° C. and atmospheric pressure produced a total simulated precipitate amount of 41 mg/L.

The 20% water phase at 8400 kPa and 300° C. is the concentrated portion that would be removed in the steam separators 20. A total precipitate amount of 110 mg/L, which equates to about 216.5 kg/day is the amount of material that can potentially form as scale in the OTSG tubes. In practice, it is believed that only a portion of this amount will be deposited as scale, but the higher this value, the greater the chance of scale deposition. Note that silica does not contribute appreciably to the precipitate amount. The major precipitate components are CaSiO₃, andradite (Ca₃Fe₂Si₃O₁₂) and tremolite (Ca₂Mg₅Si₈O₂₂(OH)₂) compounds that contain silica and other divalent and trivalent cations.

Simulation #2. In the second simulation, the TH was reduced to les than 0.5 mg/L as CaCO₃ and all the other ions remained at the same concentration as in the first simulation. The second simulation results are shown in section B of FIG. 3. In the 20% water phase, as a result of the calcium and magnesium being at a very low concentration (about 0.1 and 0.02 mg/L respectively), the dominant precipitates are now the ferric and nickel oxides. The total amount of precipitate has been reduced by a factor of 10 as compared to the first simulation.

Simulation #3. The concentrations of all the divalent and trivalent cations, including the calcium and magnesium were reduced to 0.02 mg/L (20 parts per billion) for the third simulation and the results are presented in Section C of FIG. 3. The total amount of precipitate formed is now predicted to be less than 1 mg/L in the 20% water phase.

Simulation #4. The silica concentration in the untreated produced water is relatively low at 155 mg/L. In order to clearly demonstrate the premise that high silica operation is practical when all the divalent and trivalent cations are reduced to about 20 ppb or less, the silica concentration was increased to 350 mg/L in the fourth simulation. The only difference between the third simulation and the fourth simulation was the increase in the silica concentration from 155 to 350 mg/L. The results for the fourth simulation are shown in section D of FIG. 3.

The precipitation of 232 mg/L of silica in the boiler feedwater at 25° C. demonstrates the insolubility of silica at low temperatures. A temperature greater than 60° C. would be required to maintain the silica in solution and in SAGD plants, the de-oiled water 12 is usually about 80° C.

The 20% water phase at the OTSG operating conditions again contains no precipitated silica and there is only a 2 mg/L increase in the amount of precipitated solids as compared to the third simulation. In the cooled water phase, the total amount of precipitate is now 926 mg/L due again to the precipitation of the silica at the low temperature.

The above-described embodiments of the present invention are intended to be examples only. Alterations, modifications, and variations may be effected to the particular embodiments by those of skill in the art without departing from the scope of the invention, which is defined solely by the claims appended hereto. Other and further embodiments can be devised without departing from the general disclosure thereof. For example, the order of steps can occur in a variety of sequences unless otherwise specifically limited. The various steps described herein can be combined with other steps, interlineated with the stated steps, and/or split into multiple steps. Similarly, elements have been described functionally and can be embodied as separate components or can be combined into components having multiple functions.

The inventions have been described in the context of preferred and other embodiments and not every embodiment of the invention has been described. Obvious modifications and alterations to the described embodiments are available to those of ordinary skill in the art. The disclosed and undisclosed embodiments are not intended to limit or restrict the scope or applicability of the invention conceived of by the Applicants, but rather, in conformity with the patent laws, Applicants intend to fully protect all such modifications and improvements that come within the scope or range of equivalent of the following claims.

What is claimed is:

1. A process for treating water to reduce high-temperature silica-based scaling comprising:
providing water having a silica concentration and a cation concentration; and
reducing the amount of cations to thereby produce a treated water having a decreased propensity to form silica-based high-temperature scale.

2. The process of claim 1 further comprising creating steam from at least a portion of the treated water.

3. The process of claim 2 further comprising using the steam in a steam-based enhanced oil recovery process.

4. The process of claim 3 further comprising using the steam in a Steam-Assisted Gravity Drainage process for hydrocarbon recovery.

5. The process of claim 1 wherein the cations are reduced to about 40 parts per billion or less

6. The process of claim 1 wherein the cation reduction process comprises reducing divalent cations to about less than 40 parts per billion and reducing trivalent cations to about less than 40 parts per billion.

7. The process of claim 1 wherein the cation reduction process comprises reducing divalent cations to about 30 parts per billion or less and reducing trivalent cations to about 30 parts per billion or less.

8. The process of claim 1 wherein the cation reduction process comprises reducing divalent cations to about 20 parts per billion or less and reducing trivalent cations to about 20 parts per billion or less.

9. The process of claim 1, wherein the cation removal process comprises one or more ion exchange process.

10. The process of claim 9, wherein the ion exchange process comprises a chelating ion exchange process.

11. The process of claim 10 wherein the cation removal process comprises a primary and/or polishing process to reduce the total water hardness to less than about 0.5 mg/L.

12. The process of claim 11 wherein the primary and/or polishing process is a strongly or weakly acidic cation ion exchange process.

13. The process of claim 1 wherein the total dissolved solids concentration in the water is less than about 6000 mg/L.

14. A process for treating produced water from a steam-based enhanced oil recovery process to reduce silica scaling in steam generation equipment comprising:
subjecting the produced water to a primary and/or polishing process to reduce total hardness to less than about 0.5 mg/L;
subjecting the produced water to a chelating ion exchange process to create a treated water having a divalent cation concentration of about less than 40 parts per billion and a trivalent cation concentration of about less than 40 parts per billion; and
introducing the treated water a steam generator to create steam for use in a hydrocarbon reservoir.

15. The process of claim 14 further comprising generating about 80% quality steam and about 20% water phase and wherein silica and total dissolved solids (TDS) are substantially present in the 20% water phase.

16. The process of claim 15, wherein the treated water has a divalent cation concentration of about 30 parts per billion or less and a trivalent cation concentration of about 30 parts per billion or less.

17. The process of claim 15, wherein the treated water has a divalent cation concentration of about 20 parts per billion or less and a trivalent cation concentration of about 20 parts per billion or less.

18. A system for treating water to reduce silica-based scaling in steam generation equipment comprising:
a first ion exchange apparatus for reducing the total hardness of the water to less than about 0.5 mg/L as CaCO₃; and
a second ion exchange apparatus operatively connected to the first apparatus and adapted to reduce the divalent and trivalent cation concentrations of the water to less than about 40 parts per billion and 40 parts per billion, respectively.

19. The system of claim 18 wherein the second apparatus is a chelating ion exchange unit.

20. A system for generating steam comprising
an ion exchange apparatus adapted to treat the water by reducing the cation concentrations to less than about 40 parts per billion; and
a steam generator operatively coupled to the ion exchange apparatus for producing steam from the treated water.
